(19) United States
(12) Patent Application Publication
(10) Pub. No.: US 2006/0222789 A1
(43) Pub. Date: Oct. 5, 2006

(54) Extruded ink-receiving layer for use in inkjet recording

(76) Inventors: Narasimharao Dontula, Rochester, NY (US); Cheryl J. Brickey, Webster, NY (US); Thomas J. Dannhauser, Pittsford, NY (US); Sharon R. Girolmo, Livonia, NY (US); Steven J. Neerbasch, Rochester, NY (US)

Correspondence Address: Paul A. Leipold;Patent Legal Staff, Eastman Kodak Company, 343 State Street, Rochester, NY, 14650-2201, US

(21) Appl. No.: 11/099,398

(22) Filed: Apr. 5, 2005

(51) Int. Cl. B41M 5/00

(52) U.S. Cl. 428/32.38

(57) ABSTRACT

An inkjet recording element comprising a support coated with an immiscible polymer blend to overcome limitations of existing hydrophilic materials for extrusion coating. The two phases correspond, respectively to a first composition comprising a hydrophobic thermoplastic polymer such as a polyolefin, which does not absorb water, and a second composition comprising a hydrophilic thermoplastic polymer, for example, polyvinyl alcohol, modified ethyl vinyl alcohol, polyether block polyamide, or the like. The characteristics of the polymers are such that hydrophilic thermoplastic polymer encapsulates the polyethylene layer during extrusion and produces a swellable inkjet receiver layer. Also disclosed are methods for making and a method of printing on such inkjet recording elements.

### FIELD OF THE INVENTION

The present invention relates to an inkjet recording element which comprises, on a support, a swellable ink-receiving layer made using an extruded sheet material. In particular, the inkjet recording element comprises an immiscible polymer blend in which domains of a hydrophobic thermoplastic polymer that does not absorb water are surrounded by a continuous phase comprising a hydrophilic thermoplastic polymer. Also disclosed is a method for making the inkjet recording element according to the present invention and a method of printing on an inkjet recording element according to the present invention.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water, an organic material such as a monohydric alcohol, a polyhydric alcohol, or mixtures thereof.

An inkjet recording element typically comprises a support having on at least one surface thereof one or more ink-receiving or image-forming layers, and includes those intended for reflection viewing, which have an opaque support, and those intended for viewing by transmitted light, which have a transparent support.

In order to achieve and maintain high quality images on such an inkjet recording element, the recording element must exhibit no banding, bleed, coalescence, or cracking in inked areas; exhibit the ability to absorb large amounts of ink (including carrier liquid) and dry quickly to avoid blocking; exhibit high optical densities in the printed areas; exhibit freedom from differential gloss; exhibit high levels of image fastness to avoid fade from contact with water or radiation by daylight, tungsten light, or fluorescent light or exposure to gaseous pollutants; and exhibit excellent adhesive strength so that delamination does not occur.

Inkjet recording elements tend to fall into broad categories, porous media and non-porous or swellable media. The term “non-porous media” is defined as an element comprising an image-receiving layer that absorbs applied ink essentially by means of liquid diffusion rather than capillary action associated with a porous material. The particle to binder geometry of a porous material, in contrast to a swellable material, corresponds to a composition that meets its critical pigment volume concentration (CPVC).

A typical swellable inkjet recording element from the prior art comprises a topcoat ink-receiving layer containing hydroxypropylmethyl cellulose, poly(vinyl alcohol) and/or polyurethane. Such a topcoat layer is typically applied to a surface of a base layer, using a solvent that is subsequently removed by drying, and is specially formulated to provide ink receptive properties.

Current methods for applying water-soluble polymers onto substrates involve dissolving the polymers and other additives in a carrier fluid to form a coating solution. Suitable carrier fluids may comprise organic solvents and/or water. The coating solution is then applied to the substrate by a number of coating methods, such as roller coating, wire-bar coating, dip coating, air-knife coating, curtain coating, slide coating, blade coating, doctor coating, and gravure coating. In some instances, the coating solution may be coated as a solution using a slot-die.

The major disadvantage with using such conventional coating methods is that an active drying process is required to remove water or solvent from the coating after the coating has been applied to the substrate. Typically, these drying processes involve the use of thermal ovens, and there is a limited choice of substrates that can be conveniently dried in such ovens. Many substrates do not have adequate thermal resistance. These drying processes can also place the ink-jet media manufacturer at a competitive cost disadvantage. For example, the speed of a media manufacturing line is limited by the slow drying rate of the coatings. The cost problems are compounded when multiple coatings, requiring multiple drying steps, are applied to the media.

In contrast to solvent coating, hot-melt extrusion-coating technology is a high-speed process. Extrusion-coating technology is conventionally used in the packaging industry. In such coating processes, hot-melt extrudable compositions that contain little or no organic solvents or water, are extruded onto a substrate. By employing various thermoplastic resins, such as polyolefins and ethylene copolymers, extrusion coatings can provide strength, moisture-vapor barriers, oxygen barriers, gas permeability, abrasion resistance, flame retardancy, flexibility, and elasticity for packaging and other industrial products.

In an effort to avoid the above-mentioned adverse consequences of the conventional coating methods for the manufacture of inkjet recording elements, melt extrusion of ink-receiving layers has been tried. However, in the case of non-porous or swellable ink-receiving layers, many water-soluble polymers, such as high molecular weight polyvinyl pyrrolidone, polyvinyl alcohol, natural polymers, and gums, are not suitable for forming melt extrudable compositions, because these materials tend to degrade and decompose at their melting point temperatures. Hydrophilic thermoplastic polymers tend to decompose at the higher temperatures typically employed in melt extrusion. Furthermore, hydrophilic materials are also difficult to extrusion coat because they have poor melt strength. This leads to poor curtain or film quality and very low line speeds. Thus, melt extrusion of ink-receiving layers has had limited use.

U.S. Pat. No. 6,726,981 to Steinbeck et al. relates to a recording material for inkjet printing having an extruded-polymer layer that comprises a polyether group-containing thermoplastic copolymer, including polyether amide block copolymers having a polyamide segment and a polyether segment. Further thermoplastic polymers in mixture with the copolymer are listed, including polyolefins, ethylene copolymers, polyesters, polycarbonates, polyurethanes, and/or extruded polyvinyl alcohol homopolymers and copolymers, Steinbeck et al. states that the additional thermoplastic polymers can be present in the amount of 1 to 50 weight percent based on the polymer mixture. Immiscible blends are not mentioned. None of the actual examples in the patent includes a blend of polymers in the extruded polymer layer. Finally, the media of Steinbeck et al. has a porous ink-receiving layer over the extruded layer.

U.S. Pat. No. 6,403,202 to Gu et al. discloses a recording material for inkjet printing having an extrudable polyvinyl-alcohol-containing layer which is extruded directly on raw base paper, and an ink-receiving layer which is applied as an aqueous dispersion or solution. The patent discloses the optional addition of other polymers (without specifying amounts), which list includes polyurethanes, polyolefins, ethylene copolymers, polyalkylene oxides, polycarbonates, polyesters, polyamides and polyester amides. The Examples, however, do not disclose any polymers in addition to PVA or PVA copolymers in the extruded layer. Furthermore, the use of immiscible blends of polymers for making an ink-receiving layer is not mentioned. A swellable ink-receiving layer comprising polyvinyl alcohol and cationic polymers are applied over the extruded layer.

U.S. Pat. No. 6,623,841 to Venkatasanthanam et al. discloses an ink-receptive layer that is formed from a melt processable blend of a water-soluble polymer and a substantially water-insoluble polymer, in the amounts, respectively, of 20 to 80 weight percent for each polymer. Preferred water-soluble polymers include polyvinyl alcohols and polyalkyloxazolines. The substantially water-insoluble polymer component of the blend is selected from polyolefins, polyesters, polystyrenes, and mixtures thereof. A particularly preferred blend is an alcohol/polyester blend that comprises approximately 60 percent by weight of the aliphatic polyester and approximately 40 percent by weight of the polyvinyl alcohol. The ink-receptive layer is applied over a base layer comprising a water-insoluble thermoplastic polymer, which base layer is preferably coextruded with the ink-receptive layer.

The patent to Venkatasanthanam et al. state that certain types of hydrophobic aliphatic polyesters or polyolefins are preferred because they are miscible with polyvinyl alcohol and at a reasonable concentration become the continuous phase of the blend, which is substantially water-insoluble. As the continuous phase, these hydrophobic aliphatic polyesters or polyolefins are described to provide the ability to control the degree of hydrophilicity of an ink receptive surface. Compatibilizing agents can also be used in the blend, preferably an anhydride modified polylolefin compatibilizer having a polyolefin backbone miscible in the polyolefin blend component and anhydride groups capable of reacting with the oxazoline groups of the polyalkyl oxazoline blend component. However, the amounts of hydrophobic polymer, hydrophilic polymer, and compatibilizing agents are not described in the examples presented. Venkatasanthanam et al. do not teach a hydrophilic polymer component is the continuous phase of an immiscible blend.

Venkatasanthanam et al. employ cast extrusion and do not teach material characteristics for extrusion processes like cast extrusion or extrusion coating an ink-receiving layer. Specifically, it is well known that hydrophilic resins have a narrow temperature window for processing and, hence, the hydrophobic component, and its material characteristics, is important for enhancing the processing window. In extrusion coating, one such material characteristic is melt strength which is important with respect to obtaining a melt curtain used to form an ink-receiving layer on a substrate.

U.S. Pat. No. 6,793,860 to Xing et al. discloses a method for making ink-jet recording media using hot-melt extrudable ink-receptive compositions. The melt-extrudable compositions comprise a blend of a melt-extrudable polyvinyl alcohol composition and, in addition, poly(2-ethyl-2-oxazoline), a hydrolyzed copolymer of ethylene and vinyl acetate, ethylene/acrylic acid copolymers or ethylene/methacrylic acid copolymers. Xing et al. mention the ink-receptive composition may further comprise water-soluble or water-insoluble polymers, but do not indicate amounts. All the examples are blends of water-soluble polymers.

None of the above mentioned patents discuss the required material characteristics like viscosity and melt strength to enable extrusion or extrusion coating of hydrophilic polymers. Furthermore, in the case of immiscible blend of hydrophilic polymers with hydrophobic polymers, none of the prior-art patents discuss the rheological requirements for the hydrophilic polymer being the continuous phase, or the rheological requirements of the immiscible hydrophobic polymer. Furthermore, it is important to design the requisite rheological characteristics of the immiscible blends for melt extrusion, since most hydrophilic polymers have low thermal stabilities, and have narrow temperature ranges in which they may be processed.

Extrusion of an image-receiving layer for an inkjet recording element is an economical method of manufacture, but compared to common coating techniques, it is difficult to achieve the desired properties of an image-receiving layer for use in inkjet recording. There are many unsolved problems in the art and many deficiencies in the known products, which have severely limited their commercial usefulness. A major challenge in the design of an image-recording element is to provide improved picture life, a critical component of which is resistance to light fade.

It would be desirable to have new melt extrusion compositions for making ink-jet recording media that are capable of forming high-quality, multicolored images with aqueous-based inks from inkjet printers. The present invention provides such compositions and the resulting media. It is an object of this invention to provide a multilayer inkjet recording element that has excellent image quality and improved picture life.

### SUMMARY OF THE INVENTION

These and other objects are achieved by the present invention which comprises a inkjet recording element comprising a support having thereon a swellable (non-porous) ink-receiving layer that is formed by the use of an extrudable immiscible polymer blend to overcome limitations of existing hydrophilic materials, resulting in domains of hydrophobic thermoplastic polymer in a continuous phase comprising a hydrophilic thermoplastic polymer. The hydrophobic thermoplastic polymer preferably is a polyolefin or a copolymer of polyolefin. The polyolefin used in the blend enables extrudability of the hydrophilic thermoplastic polymer. Furthermore, the invention is directed to the formulation of such a composition for obtaining a melt strength that enables melt-extrusion processes like extrusion coating.

In a preferred embodiment of this invention, the composition for the ink-receiving layer is formulated in terms of the Theological characteristics of the two types of polymers such that the immiscible polymer blend (made of the two types of polymers) provides superior performance in an inkjet receiver layer. These characteristics of the polymers are such that hydrophilic thermoplastic polymer encapsulates the hydrophobic thermoplastic polymer, for example a polyethylene polymer, during extrusion. This enables the production of a swellable inkjet receiver layer having desired ink-adsorption properties and dry time.

In one embodiment of the invention, the two types of polymers comprise, respectively, a polyolefin, specifically a polyethylene that does not absorb water and a hydrophilic thermoplastic polymer that does absorb water. In a preferred embodiment, the hydrophilic thermoplastic polymer is selected from polyvinyl alcohol, modified ethyl vinyl alcohol which may be a copolymer of ethyl vinyl alcohol and polyvinyl alcohol, polyether block polyamide, hydrophilic aliphatic thermoplastic urethanes and polyester ionomers. In a preferred embodiment the polyolefin chosen has long chain branching like low density polyethylene (LDPE) that provides melt strength to the immiscible blend for extrusion coating.

A further improvement of this invention is the use of a compatibilizing agent to control the dimension or domain size of the dispersed phase and enhance extrudability of the inkjet receiver layer.

The present invention provides the required material characteristics like viscosity and melt strength to enable extrusion coating of hydrophilic polymers. In particular, the Theological requirements for the hydrophilic polymer to be the continuous phase, in an immiscible blend, are provided by the present invention. The present invention provides such requirements as well as water absorptive characteristics of the hydrophilic polymer that is necessary for creating an ink receptive layer. Also, the present invention discusses an inherently unknown property of certain antistatic polymer compositions to serve as a component an aqueous-based ink receptive layer.

The terms “ink-receiving layer” or “ink-receptive layer” (also referred to as “hydrophilic absorbing layers”) as used herein are intended to mean a layer that is capable of receiving or absorbing aqueous-based inkjet inks. Hence, it should have good water absorptivity and be fast drying. An inkjet recording element can comprise several ink-receiving layers on a support. An ink-receiving layer can be specially intended, as its main function, to absorb either carrier fluid or ink colorant. The term “image-receiving layer” as used herein is intended to refer to the ink-receiving layer that contains the principal amount of imaged ink after the ink is applied and dried. For this reason, the image-receiving layer may optionally comprise a mordant for the ink (colorant) and is relatively thick compared to the optional layers above it. It is possible for the image-receiving layer to be divided into more than one layer such that the layers cumulatively contain the principal amount of imaged ink. The term “base layer” as used herein is intended to mean the layer or layers below the image-receiving layer that is intended to absorb a substantial amount of carrier fluid after the ink is applied.

In one preferred embodiment of the present invention, the inkjet recording element comprises, on a support, a thermoplastic non-swellable, non-porous tie layer between the support and the ink-receiving layer.

Another aspect of the invention relates to a method of making the inkjet recording element. In a preferred embodiment of the invention the above-described extrudable ink-receptive composition is co-extruded with a tie layer composition, with or without a moisture barrier composition, onto a substrate, preferably adjacent raw paper. Alternatively, such an extruded multilayer film can be stored on a roller or the like and laminated to a support such as cellulose-fiber paper. In this embodiment, if a separate moisture barrier composition is not co-extruded, then the tie layer may be formulated to also serve as a moisture barrier. In another embodiment, in which the extruded ink-receiving layer is applied onto a support having a non-cellulosic surface, no tie layer is present.

The present invention includes several advantages, not all of which are incorporated in a single embodiment. As mentioned above, extrusion of an image-receiving layer for an inkjet recording element is an economical method of manufacture, but compared to common coating techniques, it is difficult to achieve the desired properties of an image-receiving layer for use in inkjet recording. The present invention can achieve inkjet-recording properties that are improved compared to other inkjet image-receiving layer made by extrusion.

Swellable image-receiving layers tend to have superior ozone and light fade compared porous image-receiving layers. The extruded image-receiving layer of the present invention can exhibit improved light stability.

Yet another aspect of the invention relates to an inkjet printing method comprising the steps of: A) providing an inkjet printer that is responsive to digital data signals; B) loading the inkjet printer with the inkjet recording element described above; C) loading the inkjet printer with an inkjet ink; and D) printing on the inkjet recording element using the inkjet ink in response to the digital data signals.

As used herein, the terms “over,” “above,” “under,” and the like, with respect to layers in the inkjet media, refer to the order of the layers over the support, but do not necessarily indicate that the layers are immediately adjacent or that there are no intermediate layers.

### DETAILED DESCRIPTION OF THE INVENTION

As noted above, the swellable inkjet recording element of the present invention comprises, as an ink-receiving layer, an extruded non-porous, swellable absorbing layer that comprises hydrophilic thermoplastic polymer or polymers as the continuous phase.

A hydrophilic thermoplastic polymer is inherently capable of gaining greater than 30% by weight of water by absorption over 24 hours at 20° C., wherein the gain in weight is measured at 50% relative humidity (R.H.). Preferably, the at least one hydrophobic thermoplastic polymer is substantially insoluble in water, and less than 5 weight percent dissolves in water over 24 hours at 25° C.

The inventive ink-receiving layer must effectively absorb both the water and humectants commonly found in printing inks as well as the recording agent (typically a dye-based colorant). Further ink-receiving layers, either above (overcoat) or below (inner layer or the base layer) are optional, in which case the ink colorant or image-forming portion of the ink may form a gradient within the recording element and may be present, to at least some degree in more than one ink-receiving layer, typically forming a colorant gradient to some extent.

In a preferred embodiment, the inventive ink-receiving layer can function as an image-receiving layer. As mentioned above, the ink-receiving layer is intended to receive and contain most of the colorant, preferably more than 50% by weight of the applied colorant employing a typical inkjet dye-based composition. Alternatively, the inventive ink-receiving layer can be used as a base layer and an image-receiving layer can be coated over it.

Preferred hydrophilic thermoplastic polymers for the ink-receiving layer according to the present invention can comprise thermoplastic urethane, poly (vinyl alcohol) (PVA), cellulose ethers and their derivatives, polyvinyloxazoline, such as poly(2-ethyl-2-oxazoline) (PEOX), polyvinylmethyloxazoline, polyvinylmethyloxazoline, polyoxides, polyethers, poly(methacrylic acid), n-vinyl amides including thermoplastic urethane, polyether-polyamide copolymers, polyvinyl pyrrolidinone (PVP), and poly(vinyl alcohol) derivatives and copolymers, such as copolymers of poly(ethylene oxide) and poly(vinyl alcohol) (PEO-PVA) and copolymers of poly(ethylene vinyl alcohol) and poly(vinyl alcohol). Derivitized poly(vinyl alcohol) includes, but is not limited to, polymers having at least one hydroxyl group replaced by ether or ester groups, which may be used in the invention, for example an acetoacetylated poly(vinyl alcohol). Another copolymer of poly(vinyl alcohol), for example, is carboxylated PVA in which an acid group is present in a comonomer. More than one hydrophilic polymer may be present in a layer. The hydrophilic thermoplastic polymers preferably have a typical melt viscosity of 25 to 4,500 Pa-sec @ 210° C. and a shear rate of 0.1 s⁻¹. More preferably, the viscosity of the hydrophilic polymer should be in the range of 100 to 1,000 Pa-sec @ 210° C. and a shear rate of 0.1 s⁻¹.

Polyvinyl alcohols that may be used according to the invention are all polyvinyl alcohols which are extrudable or which are made extrudable by the addition of appropriate additives such as plasticizers. Some of the commercially available polyvinyl alcohol grades may contain inorganic additives like calcium carbonate, talc etc. added to it. The poly(vinyl alcohol) and copolymers thereof, employed in a preferred embodiment of the invention, has a degree of hydrolysis of at least about 50%, preferably at least about 75% and preferably less than 90 percent. Commercial embodiments of such poly(vinyl alcohol) are P2 grade of polymers from PVAXX group (Wiltshire, United Kingdom); AQUASOL polymers from A. Schulman (Akron, Ohio, USA), C-10, C-25 and W-40 grades from Adept Polymers Limited (Manchester, United Kingdom) and copolymers include EXCEVAL grade of polymers EVOH-co-PVOH from Kuraray Chemical (Japan). Preferred poly(vinyl alcohols) are cold-water soluble grades.

Melt-extrudable grade polyvinyl alcohol compositions are known in the art and are described in Famili et al., U.S. Pat. No. 5,369,168; Robeson et al., U.S. Pat. No. 5,349,000; Famili et al., U.S. Pat. No. 5,206,278; and Marten et al., U.S. Pat. No. 5,051,222, the disclosures of which are hereby incorporated by reference.

Related to melt viscosity, the melt flow index (MFI) of the preferred polyvinyl alcohol resins or other hydrophilic thermoplastic polymers used in the invention may be 10 to 50 g/10 minutes, more preferably 20 to 30 g/10 minutes. Melt flow index of the PVA polymers is measured according to ASTM D1238 test at temperatures ranging from 200° C. to 220° C. Melt flow index of polymers when tested at temperatures other than 190° C. is sometimes stated as melt flow rates.

The melt-extrudable compositions include chemically modified polyvinyl alcohols and polyvinyl alcohol copolymers. For example, a melt-extrudable polyvinyl alcohol copolymer containing 94 to 98 mol % vinyl alcohol and 2 to 6 mol % of a copolymerized monomer such as methyl methacrylate can be used. For example, a melt-extrudable chemically modified polyvinyl alcohol containing 1 to 30 wt. % of a polyhydric alcohol plasticizer such as glycerol or polyethylene glycol; a mineral acid such as phosphoric acid; and 0.05 to 1.0 wt. % of a dispersing agent such as glycerol mono-oleate can be used. The melt-extrudable polyvinyl alcohol compositions have a lower degree of crystallinity in their structures versus polyvinyl alcohol compositions that are not melt-extrudable. In one embodiment of the invention, the hydrophilic thermoplastic polymer comprises a polyether amide block copolymer, wherein a block polymer with a number of polyether groups of 2 to 20 in each of the repeating copolymer segments provides especially good results.

Polyether amide block copolymers suitable according to the invention are, for example, those of the general formula 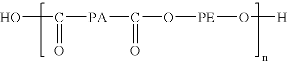
wherein PA is a polyamide segment and PE is a polyether segment. The individual segments can be connected to one another by carboxyl groups. A polyether segment can have 2 to 30, preferably 5 to 20 functional ether groups. In a further preferred embodiment of the invention, the polyether group-containing copolymer is a polyether ester copolymer. A preferred copolymer of polyether and polyamide is PEBAX, commercially available from Arkema group previously known as Atofina (Philadelphia, Pa.).

Suitable hydrophobic thermoplastic polymers for forming an immiscible blend with the hydrophilic thermoplastic polymer according to the invention are thermoplastic polymers, preferably polyolefin polymers such as ethylene copolymers, polyesters, polycarbonates, and polyurethanes. The non-crosslinked hydrophobic thermoplastic polymers should be immiscible with the hydrophilic thermoplastic polymeric phase.

The preferred olefin non-crosslinked polymers which may be blended with the hydrophilic thermoplastic polymer are a homopolymers or copolymers of polypropylene or polyethylene. Polyethylene and copolymers thereof are preferred.

The preferred polyolefin non-crosslinked polymer particles used according to this invention are immiscible with the hydrophilic component of the extruded film and exists in the form of discrete non-crosslinked polymer domains dispersed throughout the oriented and heat set film in the recording element.

In one embodiment of the invention, the preferred hydrophilic thermoplastic polymer is a polyether-polyamide copolymer such as, e.g., PEBAX or a PVOH-EVOH copolymer such as and EXCEVAL. These resins are not individually extrusion coatable, although physical blends according to the invention were extrusion coatable.

In one embodiment of the invention the hydrophilic thermoplastic polymer is a polyester ionomer. The “ionomers” or “polyester ionomers” used in the present invention contain at least one ionic moiety, which can also be referred to as an ionic group, functionality, or radical. In a preferred embodiment of this invention, the recurring units containing ionic groups are present in the polyester ionomer in an amount of from about 1 to about 12 mole percent, based on the total moles of recurring units. Such ionic moieties can be provided by either ionic diol recurring units and/or ionic dicarboxylic acid recurring units, but preferably by the latter. Such ionic moieties are anionic. Exemplary anionic ionic groups include carboxylic acid, sulfonic acid, and disulfonylimino and their salts and others known to a worker of ordinary skill in the art. Sulfonic acid ionic groups, or salts thereof, are preferred.

The polyester ionomers used in this invention have a glass transition temperature (T_{g}) of about 80° C. or less and, preferably, from about 25° C. to 70° C. T_{g} values can be determined by techniques such as differential scanning calorimetry or differential thermal analysis, as disclosed in N. F. Mott and E. A. Davis, Electronic Processes in Non-Crystalline Material, Oxford University Press, Belfast, 1971, at p. 192. Preferred polyester ionomers for use in the present invention include the EASTEK polymers previously known as EASTMAN AQ polymers manufactured by Eastman Chemical Company of Kingsport, Tenn. With reference to the preferred polyester ionomer material for the image-receiving layer, monomeric units derived from 1,4-cyclohexane dimethanol (CHDM) are also referred to as “CHDM repeat units” or “CHDM comonomer units.”

The ionomer polymers of this invention are relatively high molecular weight (Mₙ preferably above 10,000, more preferably above about 14,000) substantially amorphous polyesters that disperse directly in water without the assistance of organic co-solvents, surfactants, or amines. As indicated above, this water dispersibility is attributable in large part to the presence of ionic substituents, for example, sulfonic acid moieties or salts thereof, for example, sodiosulfo moieties (SO₃Na) in the polymer. Properties of these polymers are described in Publication No. GN-389B of Eastman Chemical Company, dated May 1990, the disclosures of both of which are incorporated herein by reference. Especially preferred is poly[1,4-cyclohexylenedimethylene-co-2,2′-oxydiethylene (46/54) isophthalate-co-5-sodiosulfo-1,3-benzenedicarboxylate (82/18)] (obtained as EASTEK 1100, previously sold as EASTMAN AQ 55 polymer, T_{g} 55° C. from Eastman Chemical Co.).

The commercially available salt forms of the polyester ionomer, including the aforementioned EASTEK polymers, have been shown to be effective in the present invention.

In one embodiment of the invention the hydrophilic thermoplastic polymer is a aliphatic thermoplastic polyurethane like the TECOPHILIC grades available from Noveon (Wilmington, Mass., USA)

The immiscible mixture is formed according to the present invention by means of a preselected viscosity ratio and volume fraction of the components. In particular, the immiscible mixture of a continuous phase and domains of a discontinuous phase, wherein the continuous phase comprises at least one hydrophilic thermoplastic polymer and the domains comprise at least one hydrophobic thermoplastic polymer that is non-crosslinked, satisfies the following equation:

$${ϕ}_{2} > {ϕ}_{1} ( \frac{{η}_{2}}{{η}_{1}} ) \qquad ( 1 )$$

wherein η₁ and η₂ are, respectively, the melt viscosity at the same shear rate and temperature of, respectively, the hydrophobic thermoplastic polymer total composition and the hydrophilic thermoplastic polymer total composition. In the above equation, φ₁ and φ₂ are the total volume fractions of the hydrophobic thermoplastic polymer total composition and hydrophilic thermoplastic polymer total composition, wherein the sum of φ₁ and φ₂ equal one. If melt densities of the polymers used in the extrusion are known, then the volume fractions can be determined from the weight fractions of the polymers. The shear rates of interest are those experienced by the polymer composition during extrusion. This generic empirical relationship has been found to describe a structure where the hydrophilic thermoplastic polymer forms the continuous phase and the hydrophobic thermoplastic polymer forms the discrete or discontinuous phase.

In the event there are a plurality of hydrophilic thermoplastic polymers and/or hydrophilic thermoplastic polymers, the parameters η₁ and η₂ are, respectively, the melt viscosity of the total composition of the hydrophobic thermoplastic polymers and total composition of the hydrophilic thermoplastic polymers, and φ₁ and φ₂ are their respective total volume fractions.

The above equation does not include compatibilizers, surfactants, mordants and other possible polymers that form on the interfacial surface of the separate phases. In contrast, plasticizers are included in the calculation. For example, plasticizers which are hydrophilic polymers within the hydrophilic discrete phase, even in amounts of a few percent, can significantly affect melt viscosity of the relevant composition and should be taken into account in the above equation.

In the case where the ink-receiving layer comprises a single hydrophilic thermoplastic polymer, or substantially single such polymer, and the dispersed domains comprise a single hydrophobic thermoplastic polymer, or substantially single such polymer, then η₁ and η₂ are therefore, respectively, the melt viscosity of the hydrophobic thermoplastic polymer and the hydrophilic thermoplastic polymer, and φ₁, and φ₂ are the volume fraction of the hydrophobic thermoplastic polymer and hydrophilic thermoplastic polymer.

Preferably, the hydrophilic thermoplastic polymer composition is about 40 to 85, preferably 50 to 75, percent by weight of the total weight of the hydrophobic thermoplastic polymer and the hydrophilic thermoplastic polymer in the layer. Similarly, the hydrophobic thermoplastic polymer composition is preferably 15 to 60, preferably 25 to 50, percent by weight of the total.

In one embodiment, the inkjet recording element of the invention satisfies the following equation is satisfied:

$${ϕ}_{2} > {ϕ}_{1} ( \frac{{η}_{2}}{{η}_{1}} ) \qquad ( 1 )$$

wherein η₁ and η₂ are, respectively, the melt viscosity (at the same shear rate and temperature) of a sole hydrophobic thermoplastic polymer and a sole hydrophilic thermoplastic polymer, and φ₁ and φ₂ are their respective volume fractions, wherein the sum is equal to one.

In one embodiment, in which the composition is extruded, the composition of the continuous phase and the composition of the discontinuous phase are both thermally stable at 150° C., preferably 200° C. Preferably the single or principal polymers (the major amount in terms of weight percent), the principal hydrophilic thermoplastic polymer and the principal hydrophobic thermoplastic polymer are also both thermally stable at 150° C., preferably 200° C.

The melt strength of the material forming the ink-receiving layer is suitably in the range of about 0.5 to 20 centiNewtons (cN) at 210° C., in one preferred embodiment about 1 to 10 cN. The melt strength of the polymers may be measured using a melt tension apparatus like the Rheotens provided by Gottfert. Other apparatuses similar to Rheotens can also be used to characterize melt strength. This test quantifies the resistance offered by resin during a melt stretching process. Melt tension or melt strength of the resin is determined by stretching a strand of polymer extruded out of a die between two counter-rotating wheels. The frequency of rotation of the wheels is increased by a preset acceleration and this results in the polymer strand being stretched. The pulling force measured in centiNewtons (cN) during the stretching process is continuously recorded until the polymer strand breaks. The maximum force obtained before break of the strand is known as melt tension or melt strength of the polymer at the particular temperature. As a standard test, the foregoing procedure may be performed as described by M. B. Bradley and E. M. Phillips in the Society of Plastics engineers ANTEC 1990 conference paper (page 718), hereby incorporated by reference. Here, a capillary die of dimension 30 mm length with 2 mm diameter was used for these measurements while keeping the air gap (distance between die to first nip) at 100 mm.

Optionally, compatiblizers as described below can be used to control and reduce domain size of dispersed polymer. Preferably, the domains have an average equivalent diameter of 0.05 to 50 μm, more preferably 0.1 to 10 μm as measured by optical microscopy or scanning electron microscopy. Also, mordants can optionally be added as also described below.

Additives that improve the extrusion properties of the hydrophilic thermoplastic polymer are, for example, plasticizers. A plasticizer may be incorporated into the polymer matrix during the preparation of the polyvinyl alcohol or may simply be added to the extruder and mixed therein with the hydrophilic thermoplastic polymer. Suitable plasticizers that are compatible with the hydrophilic thermoplastic polymer are, for example, polyhydric alcohols, such as glycerol, polyethylene glycol, ethylene glycol, diethylene glycol and mannitol. The plasticizer or a plasticizer mixture containing several plasticizers may amount to 1 to 30 wt %, preferably 5 to 20 wt %, based on the weight of the extrusion coated layer.

The coating weight of the extruded layer may be 10 to 60 g/m 2, preferably 20 to 40 g/m 2. The extrusion is performed according to methods which are known to the skilled worker in the paper manufacturing industry. The extruder is, for example, a screw extruder. According to a preferred embodiment of the invention, the temperature in the extruder or the temperature in different sections of the extruder is adjusted to 140 to 300° C., in particular 160 to 250° C. In particular, in a two-inch extruder it is preferred to compound the resins and further optional additives with screw speeds of more than 50 rpm, in particular more than 75 rpm, and to extrude the resulting mixtures. If an extruder other than a two-inch extruder is used, it is preferred to adjust the screw speed in such a way that the viscosity of the material to be extruded corresponds to the viscosity of a material which is compounded and extruded in a two inch screw extruder at screw speeds of more than 50 rpm and a temperature of 140 to 300° C. In order to achieve high gloss it is preferred to use a high gloss chill roll.

The thickness of the extruded ink-receiving layer according to the present invention is from 1 μm to 50 μm, preferably 1 to 25 μm (more preferably 5 μm to 12 μm). The preferred dry coverage of an optional non-extruded overcoat layer, described below, is from 0.5 μm to 5 μm (more preferably 0.5 μm to 1.5 μm) as is common in practice. In the case of an optional base layer, the dry-layer thickness of the base layer is preferably from 5 μm to 60 μm (more preferably 6 μm to 15 μm).

The inkjet recording element of claim 1 wherein layer thickness of a tie layer is from 1 μm to 15 μm, the dry coverage of the optional overcoat layer is from 0.5 μm to 1.5 μm, and the dry layer thickness of the optional base layer is from 6 μm to 15 μm.

Referring again to the extruded ink-receiving layer of the present invention, dye mordants can be added to the image-receiving layer and optionally also in optional additional layers, including overcoats or inner hydrophilic absorbing layers, in order to improve smear resistance at high relative humidity. Mordants conventionally include “cationic polymeric mordant” which are typically polymers comprising the reaction product of a cationic monomer (mordant moiety) which monomer comprises free amines, protonated free amines, and quaternary ammonium, as well as other cationic groups such as phosphonium. The phosphonium polymers are preferred, compared to amines and the like because of their improved thermal stability. Inorganic mordants such as zinc oxide, cerium oxide, titanium oxide, and yttrium oxide are also preferred because of their thermal stability.

The amount of mordant used, especially in the image-receiving layer, should be high enough so that the images printed on the recording element will have a sufficiently high density. In a preferred embodiment of the invention, the mordants, preferably having a cationic charged surface, are used in the amount of about 5 to 30 weight percent solids, preferably 10 to 20 weight percent in the image-receiving layer, based on total weight of the dried coating.

In the case of inorganic mordants, the use of extremely fine particles (less than 10 micron diameter) is desired, preferably less than 1 microns diameter, more preferably less than 0.1-micrometer diameter. For a constant weight of inorganic mordant, decreasing particle size results in increased cationic surface area to be available to bind anionic dyes. For example, yttrium oxide powders can be purchased commercially with particle sizes from 3-5 microns (Stanford Materials, California, USA), less than 0.5 microns (Stanford Materials) and 0.03-0.05 micrometers (Inframat Advanced Materials, Connecticut, USA).

In one embodiment, a compatibilizer is used to determine the final morphology of the dispersed phase. A preferred compatibilizer is a block polymer which has a structure such that blocks of a polyolefin and blocks of a hydrophilic thermoplastic polymer are bonded together alternately and repeatedly. Preferably, the blocks of the hydrophilic thermoplastic polymer are polyether blocks. The polyether blocks can be formed from one or more alkylene oxides having 2 to 4 carbon atoms. The polyether blocks can comprise ethylene oxide, propylene oxide, or butylene oxide, or combinations thereof, preferably comprising at least 50 mole % ethylene oxide in the polyoxyalkylene chains. Typically, the polyolefins are obtained by polymerization of one or a mixture of two or more olefins containing 2 to 30 carbon atoms, preferably containing 2 to 12 carbon atoms, particularly preferably propylene and/or ethylene. Alternatively, low molecular weight polyolefins can be obtained by thermal degradation of high molecular weight olefins. The number average molecular weight of the polyolefin is preferably 800 to 20,000.

In one embodiment, the compatibilizer polymer is a block polymer having a structure such that the polyolefin block and the polyether block are bonded together alternately and repeatedly such that the polymers have a repeating unit represented by the following general formula (1).

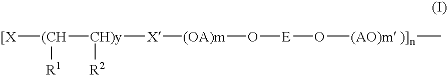

In the general formula (I), n is an integer of 2 to 50, one of R¹ and R² is a hydrogen atom and the other is a hydrogen atom or an alkyl group containing 1 to 10 carbon atoms, y is an integer of 15 to 800, E is the residue of a diol after removal of the hydroxyl groups, A is an alkylene group containing 2 to 4 carbon atoms, m and m′ each represents an integer of 1 to 300, X and X′ are connecting groups used in the synthesis of the block polymer as listed in EP 1167425 A1, hereby incorporated by reference in its entirety.

Such a block copolymer can be formed by the reaction of a mixture comprising a modified polyether and a modified polyolefin. For example, one or more polyether reactants such as polyether diols can be reacted with polyolefin reactants (obtained by modifying the termini of the polyolefin with carbonyl-containing groups or the like) and a polycondensation polymerization reaction carried out generally at 200 to 250° C. under reduced pressure employing known catalysts such as zirconium acetate.

Preferably, the compatibilizer polymer comprises a block copolymer of polyethylene oxide (polyether) segments with a polypropylene and/or polyethylene (polyolefin) segments. In one embodiment, the block polymer has a number average molecular weight of 2,000 to 200,000 as determined by gel permeation chromatography. The polyolefin of the block polymer may have carbonyl groups at both polymer termini and/or a carbonyl group at one polymer terminus.

An example of such a compatibilizer is PELESTAT 300 and PELESTAT 230 polymer, commercially available from Sanyo Chemical Industries, Ltd. (Tokyo) or Tomen America, Inc. (New York, N.Y.). The compatibilizer polymer PELESTAT 300 (a copolymer of a polyether and a polyolefin) is described in EP 1167425 A1. Other compatibilizers that may be used in this invention are functionalized polyolefins like modified polyethylenes, modified polypropylenes, copolymers of polyolefins and combinations of these resins. The preferred resin in the tie layer are ethylene methyl acrylate copolymers (EMA), copolymer of ethylene, and glycidyl methacrylate ester (EGMA) terpolymer of ethylene, methyl acrylate and glycidyl methacrylate ester (EMAGMA); terpolymer of ethylene butylacrylate and maleic anhydride (EBAMAH) ethylene vinyl acetate copolymers (EVA); ethylene methacrylic acid copolymers (EMAA); ethylene acrylic acid copolymers (EAA), maleated polyolefins and ionomers of polyolefins. Some examples of these resins are OREVAC CA100, LOTADER family of resins from Arkema group previously known as ATOFINA, OPTEMA family of resins (e.g. OPTEMA TC130, OPTEMA TC120) from Exxon Mobil Chemical Company, VORIDIAN SP2207, VORIDIAN SP2403 from Eastman Chemical Company and BYNEL grade of polymers from DuPont. The choice of the compatibilizer is based on the type of hydrophilic polymer used and the rheological properties of the system. The amount of compatibilizer used can range from 0 wt % to 20 wt % of the entire polymer mass in the ink-receiving layer. Preferred range of the compatibilizer for this invention is 2.5 wt % to 7.5 wt % of the entire polymer mass in the ink-receiving layer.

As mentioned above the melt-extrudable composition used in the present invention may contain various particulate (i.e., pigments) and other additives. Particulates may be used to provide the medium with anti-blocking properties for suitable transport properties in roll format and cut sheet format as well as to prevent ink from transferring from one medium to an adjacent medium during imaging of the media. Further additives, such as white pigments, color pigments, fillers, especially absorptive fillers and pigments such as oxides, carbonates, silicates or sulfates of alkali metals, earth alkali metals such as silicic acid, aluminum oxide, barium sulfate, calcium carbonate and magnesium silicate. alumina, aluminum hydroxide, pseudoboehmite. Further additives such as color fixation agents, dispersing agents, softeners and optical brighteners can be contained in the polymer layer. Titanium dioxide can be used as a white pigment. Further fillers and pigments are calcium carbonate, magnesium carbonate, clay, zinc oxide, aluminum silicate, magnesium silicate, ultramarine, cobalt blue, and carbon black or mixtures of these materials. The fillers and/or pigments are used in quantities of 0 to 40 wt. %, especially 1 to 20 wt. %. The quantities given are based on the mass of the polymer layer.

Further examples of inorganic and organic particulate include zinc oxide, tin oxide, silica-magnesia, bentonite, hectorite, poly(methyl methacrylate), and poly(tetrafluoroethylene). In order not to impair the gloss of the recording material, the pigment used within the ink absorbing layer may be a finely divided inorganic pigment with a particle size of 0.01 to 1.0 μm, especially 0.02 to 0.5 μm. Especially preferred, however, is a particle size of 0.1 to 0.3 μm. Especially well suited are silicic acid and aluminum oxide with an average particle size of less than 0.3 μm. However, a mixture of silicic acid and aluminum oxide with an average particle size of less than 0.3 μm can also be employed.

Matte particles may be added to any or all of the layers described in order to provide enhanced printer transport, resistance to ink offset, or to change the appearance of the ink-receiving layer to satin or matte finish. Typical additives can also include antioxidants, process stabilizers, UV absorbents, UV stabilizers, antistatic agents, anti-blocking agents, slip agents, colorants, foaming agents, plasticizers, optical brightening agents, flow agents, and the like. Anti-oxidants are particularly effective in preventing the melt-extrudable composition from discoloring.

While not necessary, the hydrophilic layers described above may also include a crosslinker. Such an additive can improve the adhesion of a layer to the substrate as well as contribute to the cohesive strength and water resistance of the layer. Crosslinkers such as carbodiimides, polyfunctional aziridines, melamine formaldehydes, isocyanates, epoxides, and the like may be used. If a crosslinker is added, care must be taken that excessive amounts are not used, as this will decrease the swellability of the layer, reducing the drying rate of the printed areas as well as cause difficulties during extrusion if done during the process. Crosslinking could be decoupled from extrusion, for example, carried out using UV radiation.

In a further embodiment of the invention the recording material can have one or more additional non-extruded or extruded layers in addition to the extruded ink-receptive layer described above. For example, in one embodiment, the extruded ink-receiving layer can function as an image-receiving layer over a base layer. This additional base layer can have the function of an carrier-fluid absorbing layer. This base layer can be applied as an aqueous dispersion or solution or might also be extruded. The base layer can be applied in the form of a single layer or multiple layers. It can contain hydrophilic or water-soluble binders, dye-fixation agents, dyes, optical brighteners, curing agents as well as inorganic and/or organic pigments.

In another embodiment of this invention, two hot-melt extrudable ink-receptive compositions are formed and co-extruded onto a substrate to form a multi-layered structure. In another embodiment an ink-receptive layer can be extruded with a tie layer. In yet another embodiment, a moisture barrier can be coextruded, for example, particularly when the support is raw paper. Thus, for example, in one embodiment of the invention, an inkjet recording element can comprise: (a) an extruded ink-receiving layer according to the present invention as described above; and (b) beneath the ink-receiving layer, an optional extruded tie layer; and (c) beneath the optional tie layer, an optional extruded or non-extruded moisture barrier layer, and (d) on bottom, a support.

Also, ink-receiving layers or topcoats additional to one or more extrude ink-receiving layers can be formed using conventional coating, for example, an overcoat or a further ink-receiving layer. With respect to such additional optional non-extruded ink-receiving layers, coating compositions employed in the invention may be applied by any number of well known techniques, including dip-coating, wound-wire rod coating, doctor blade coating, gravure and reverse-roll coating, slide coating, bead coating, extrusion coating, curtain coating and the like. Known coating and drying methods are described in further detail in Research Disclosure no. 308119, published December 1989, pages 1007 to 1008. Slide coating is preferred, in which the base layers and overcoat may be simultaneously applied. After coating, the layers are generally dried by simple evaporation, which may be accelerated by known techniques such as convection heating.

The non-extruded coating composition can be coated either from water or organic solvents. However, water is preferred. The total solids content should be selected to yield a useful coating thickness in the most economical way, and for particulate coating formulations, solids contents from 10-40% are typical.

Additives that can be added to an optional solvent-coated layer are well known in the art, including additives to improve colorant fade, UV absorbers, radical quenchers or antioxidants. Other additives include pH modifiers, adhesion promoters, rheology modifiers, surfactants, biocides, lubricants, dyes, optical brighteners, matte agents, antistatic agents, etc. In order to obtain adequate coatability, additives known to those familiar with such art such as surfactants, defoamers, alcohol and the like may be used. A common level for coating aids is 0.01 to 0.30% active coating aid based on the total solution weight. These coating aids can be nonionic, anionic, cationic or amphoteric. Specific examples are described in MCCUTCHEON's Volume 1: Emulsifiers and Detergents, 1995, North American Edition.

In another embodiment of the invention, a filled layer containing light-scattering particles such as titania may be situated between a clear support material and the ink-receiving or hydrophilic absorbing layers described herein. Such a combination may be effectively used as a backlit material for signage applications. Yet another embodiment which yields an ink receiver with appropriate properties for backlit display applications results from selection of a partially voided or filled poly(ethylene terephthalate) film as a support material, in which the voids or fillers in the support material supply sufficient light scattering to diffuse light sources situated behind the image.

The support for the inkjet recording element used in the invention can be any of those usually used for inkjet receivers, such as resin-coated paper, paper, polyesters, or microporous materials such as polyethylene polymer-containing material sold by PPG Industries, Inc., Pittsburgh, Pa. under the trade name of TESLIN, TYVEK synthetic paper (DuPont Corp.), and OPPALYTE films (Mobil Chemical Co.) and other composite films listed in U.S. Pat. No. 5,244,861. Opaque supports include plain paper, coated paper, synthetic paper, photographic paper support, melt-extrusion-coated paper, and laminated paper, such as biaxially oriented support laminates. Biaxially oriented support laminates are described in U.S. Pat. Nos. 5,853,965; 5,866,282; 5,874,205; 5,888,643; 5,888,681; 5,888,683; and 5,888,714. These biaxially oriented supports include a paper base and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthalate), poly(1,4-cyclohexanedimethylene terephthalate), poly(butylene terephthalate), and copolymers thereof; polyimides; polyamides; polycarbonates; polystyrene; polyolefins, such as polyethylene or polypropylene; polysulfones; polyacrylates; polyetherimides; and mixtures thereof. The papers listed above include a broad range of papers, from high end papers, such as photographic paper to low end papers, such as newsprint. In a preferred embodiment, a paper that is coated on both sides by polyethylene or poly(ethylene terephthalate) is employed.

In principal, any raw paper can be used as support material. Preferably, surface sized, calendared or non-calendared or heavily sized raw paper products are used. The paper can be sized to be acidic or neutral. The raw paper should have a high dimensional stability and should be able to absorb the liquid contained in the ink without curl formation. Paper products with high dimensional stability of cellulose mixtures of coniferous cellulose and eucalyptus cellulose are especially suitable. Reference is made in this context to the disclosure of DE 196 02 793 B1 which describes a raw paper as an ink-jet recording material. The raw paper can have further additives conventionally used in the paper industry and additives such as dyes, optical brighteners or defoaming agents. Also, the use of waste cellulose and recycled paper is possible. However, it is also possible to use paper coated on one side or both sides with polyolefins, especially with polyethylene, as a support material.

The support used in the invention may have a thickness of from 50 μm to 500 μm, preferably from 75 μm to 300 μm. Antioxidants, antistatic agents, plasticizers and other known additives may be incorporated into the support, if desired.

In order to improve the adhesion of the tie layer or, in the absence of a tie layer, the ink-receiving layer, to the support, the surface of the support may be subjected to a corona-discharge treatment prior to applying a subsequent layer. The adhesion of the ink recording layer to the support may also be improved by coating a subbing layer or glue on the support. Examples of materials useful in a subbing layer include halogenated phenols, partially hydrolyzed vinyl chloride-co-vinyl acetate polymer, polyethylene imine, alkyl titanates, polyurethanes and acrylic copolymers.

Optionally, an additional backing layer or coating may be applied to the backside of a support (i.e., the side of the support opposite the side on which the image-recording layers are coated) for the purposes of improving the machine-handling properties and curl of the recording element, controlling the friction and resistivity thereof, and the like.

Typically, the backing layer may comprise a binder and a filler. Typical fillers include amorphous and crystalline silicas, poly(methyl methacrylate), hollow sphere polystyrene beads, micro-crystalline cellulose, zinc oxide, talc, and the like. The filler loaded in the backing layer is generally less than 5 percent by weight of the binder component and the average particle size of the filler material is in the range of 5 μm to 30 μm. Typical binders used in the backing layer are polymers such as polyacrylates, gelatin, polymethacrylates, polystyrenes, polyacrylamides, vinyl chloride-vinyl acetate copolymers, poly(vinyl alcohol), cellulose derivatives, polyolefins and the like. Preferred binders are polyolefins like polyethylenes, polypropylenes and their copolymers. Additionally, an antistatic agent also can be included in the backing layer to prevent static hindrance of the recording element. Particularly suitable antistatic agents are compounds such as dodecylbenzenesulfonate sodium salt, octylsulfonate potassium salt, oligostyrenesulfonate sodium salt, laurylsulfosuccinate sodium salt, and the like. Other antistats that may be added to the backing layer binder are polymeric antistats like polyether-based copolymers or antimony doped tin oxide (add other antistats). The antistatic agent may be added to the binder composition in an amount of 0.1 to 15 percent by weight, based on the weight of the binder. An image-recording layer may also be coated on the backside, if desired.

The inventive recording materials are characterized by high gloss, which can be increased even more by treatment with a calendar or extruding the materials on a cold roller having a high gloss. They exhibit high wiping fastness while providing excellent color density and excellent mottle values. The recording material according to the invention has an improved ink absorbing capability.

Conventional melt extrusion coating techniques may be used in accordance with this invention. In such processes, a resin is first subjected to heat and pressure inside the barrel of an extruder. The molten resin is then forced through the narrow slit of an extrusion-coating die by an extruder screw. At the exit of the die slit, a molten curtain emerges. This molten curtain is drawn down from the die into a nip between two counter-rotating rolls, a chill roll, and pressure roll. While coming into contact with the faster moving substrate in the nip formed between the chill roll and the pressure roller, a hot film is drawn out to the desired thickness on the substrate.

In order to achieve gloss values as high as possible, it is advantageous to use a high gloss cooling roller or chill roll in the extrusion process. Thus, the coated substrate can be passed between a chill roll and pressure roll that presses the coating onto the substrate to ensure complete contact and adhesion. The combination of the extruder screw speed which determines output for a given die geometry and resin rheology and web line speed determines the thickness of the extrusion coatings.

In one form of a co-extrusion system, different types of molten resins from two or more extruders combine in a co-extrusion feed block to form a multi-layered structure. This multi-layered “sandwich” is then introduced into the die and will flow across the full width of the die. With co-extrusion, a multi-layered coating can be produced in a single pass of the substrate.

Preferably, barrel zone temperatures of 140° C. to 300° C., especially 160° C. to 250° C., are maintained within the extruder. The extrusion can be carried out using a single screw extruder or a twin-screw extruder. The polymer blends for the ink receptive layer can be made using a twin screw extruder (compounder) as a master batch and let down to the required composition of the ink receptive layer or the polymer blend can be made from a physical blend of the polymer pellets that is introduced into the feed system of the extruder which extrudes the ink receptive layer.

In order to increase adhesion between the ink-receptive layer(s) and the support (or an intermediate moisture barrier layer over the support), an optional tie layer can be coextruded with the extruded ink-receiving layer. A melt extrudable composition for the tie layer can comprise, for example, one or more suitable polymers such as polyolefin, polyurethane, ethylene-acrylic acid copolymer, ethylene-methacrylic acid copolymer, ethylene-acrylic acid-methacrylate terpolymer, sodium-ethylene-acrylic acid, zinc-ethylene-acrylic acid, poly(2-ethyl-2-oxazoline), and copolymers and mixtures thereof. A non-voided polyolefin material is preferred.

An optional moisture barrier coating can also be extruded onto a support using a melt extrudable composition. Suitable polymers for forming the moisture barrier coating can include, for example, homopolymers and copolymers of polyolefins, such as polyethylene and polypropylene; ethylene-acrylic acid copolymers; ethylene-acrylate copolymers; and polyesters. The moisture barrier coating may further comprise additives and particulate such as titanium dioxide, talc, calcium carbonate, silica, clay, and the like. Typically, the thickness of the moisture barrier layer is in the range of about 5 μm (0.2 mil) to about 100 μm (4 mil) and more preferably about 15 μm (0.6 mil) to about 50 μm (2 mil).

Another aspect of the invention relates to an inkjet printing method comprising the steps of: A) providing an inkjet printer that is responsive to digital data signals; B) loading the inkjet printer with the inkjet recording element described above; C) loading the inkjet printer with an inkjet ink; and D) printing on the inkjet recording element using the inkjet ink in response to the digital data signals.

Inkjet inks used to image the recording elements of the present invention are well known in the art. The ink compositions used in inkjet printing typically are liquid compositions comprising a solvent or carrier liquid, dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. The dyes used in such compositions are typically water-soluble direct or acid type dyes. Such liquid compositions have been described extensively in the prior art including, for example, U.S. Pat. Nos. 4,381,946; 4,239,543; and 4,781,758.

The following examples are provided to further explain the invention.

### EXAMPLES

### Example 1 (Comparative Control)

This example is representative of prior art and is presented here for comparison purposes. It comprises a paper raw base, 160 μm thick, made using a standard Fourdrinier paper machine utilizing a blend of mostly bleached hardwood Kraft fibers. The fiber ratio consisted primarily of bleached poplar, and maple/beech with lesser amounts of birch and softwood. Acid sizing chemical addenda utilized on a dry weight basis, included an aluminum stearate size, polyaminoamide epichlorohydrin, and polyacrylamide resin. Surface sizing using hydroethylated starch and sodium bicarbonate was also employed. This raw base was then extrusion coated on an extrusion-coating machine. The screw size on the extruder was a 3.81 cm extruder feeding a T-die. The raw base was coated on the wire side with a LDPE/HDPE blend at resin coverage of 25.4 g/m², wherein LDPE and HDPE refers, respectively, to low density polyethylene and high density polyethylene. The ratio of LDPE to HDPE in the wire side blend was 45/55. The LDPE used was D4002P (Eastman Chemical Company, now known as Voridian) and HDPE used was PE 9608 (Chevron Phillips). On the face side (the image-receiving side) a face side resin composite comprising substantially 83% LDPE, 11% TiO₂ and remaining additives was extrusion coated. Resin coverages on the face side were 24.41 gm/m². This image-receiving member was evaluated by printing a test image on it using a Hewlett-Packard model 970cxi® inkjet printer loaded with standard ink cartridges. The resulting print was not dry even hours after printing. The image was not uniform and showed severe bleeding/blurring.

### Example 2

In this example of the invention, the paper support and wire-side coating are identical to those of comparative Example 1. On the face side (the image-receiving side) a blend of 49.63% PEBAX MH1657 polyether amide block copolymer (Atofina, now known as Arkema group) with 49.63% LDPE D4002P (Eastman Chemical Co., now known as Voridian), and 0.75% zinc stearate was extrusion coated. Resin coverages on the face side was 24.41 g/m². This image-receiving member was evaluated by printing a test image on it using a Hewlett-Packard® Model 630 inkjet printer loaded with standard HP ink cartridges. The resulting print had good density and acceptable drytime.

### Example 3

In this example of the invention, the paper support and wire-side coating are identical to those of comparative Example 1. On the face side (or the image-receiving side) a blend of 48.38 weight % PEBAX MH1657 polyether amide block copolymer (from Atofina, now known as Arkema group), 48.38 weight % LDPE D4002P (from Eastman Chemical Co., now known as Voridian), 0.75 weight % zinc stearate along with 2.48% PELESTAT 300 (from Sanyo Chemical Industries or Tomen America) compatibilizer copolymer was extrusion coated. Resin coverages on face side were 24.41 g/m². This image-receiving member was evaluated in the same way as Example 2 above. The resulting print had good density, acceptable drytime, and uniform appearance.

### Example 4

In this example of the invention, the paper support and wire-side coating are identical to those of comparative Example 1. On the face side (the image-receiving side) a blend of 11 weight % TiO₂, 69 weight % LDPE D4002P (Eastman Chemical Co., now known as Voridian) and 20 weight % ethylene methyl acrylate copolymer (EMA) OPTEMA TC130 (Exxon Mobil Chemical) resin was extrusion coated. Over this layer, an ink-receiving layer was extrusion coated. This was a physical blend of 50 weight % EXCEVAL CP4103B1 (Kuraray Co.), a ethyl vinyl alcohol-poly(vinyl alcohol) copolymer, with 50 weight % LDPE 811A (Eastman Chemical Co., now known as Voridian) which was extrusion coated. The extruder screw speed was 150 rpm, and line speed was 0.15 m/s. This image-receiving member was evaluated in the same manner as example 1 above. The resulting print had good image density, good sharpness, and good dry time. The printed areas showed good uniformity.

### Example 5

In this example of the present invention, the paper support and wire-side coating are identical to those of comparative Example 1. On the face side (the image-receiving side) a blend of 11 weight % TiO₂, 69 weight % LDPE D4002P (Eastman Chemical Co., now known as Voridian) and 20 weight % EMA OPTEMA TC130 (Exxon Mobil Chemical) resin was extrusion coated. Over this layer, an ink-receiving layer was extrusion coated. This was a physical blend of 57 weight % EXCEVAL CP4103B1 (Kuraray Co.), a ethyl vinyl alcohol-poly(vinyl alcohol) copolymer with 38 weight % LDPE 811 A (Eastman Chemical Co., now known as Voridian) and 5% PELESTAT 300 (Sanyo Chemical Industries, or Tomen America) compatibilizer copolymer which was extrusion coated. Screw speed was 30 rpm, and line speed was 0.15 m/s. Resin coverages of the ink-receiving layer were 24.4 g/m².

### Example 6

In this example of the present invention, the paper support and wire-side coating are identical to those of comparative Example 1. On the face side (or the image-receiving side) a blend of 11 weight % TiO₂, 69 weight % LDPE D4002P (Eastman Chemical Co., now known as Voridian) and 20 weight % EMA OPTEMA TC130 (Exxon Mobil Chemical) was extrusion coated. Over this layer, an ink-receiving layer was extrusion coated. This was a physical blend of 80 weight % P2 C70 polyvinyl alcohol (PVAXX group) with 20 weight % LDPE 811A (Eastman Chemical Co., now known as Voridian) which was extrusion coated. The resulting resin coverages of the ink-receiving layer were 41.11 g/m².

This image-receiving member was evaluated in the same manner as example 1 above. The resulting print had excellent print density and sharpness.

Dry time was good. After several months of dark indoor storage, a delamination of the P2 C70/LDPE ink-receiving layer from the underlying base was observed along the cut edges of the print.

### Example 7

In this example of the present invention, the paper support and wire-side coating are identical to those of comparative Example 1. On the face side (or the image-receiving side) a blend of 11 weight % TiO₂, 69 weight % LDPE D4002 (Eastman Chemical Co., known as Voridian) and 20 weight % EMA OPTEMA TC130 (Exxon Mobil Chemical) was extrusion coated. Over this layer, an ink-receiving layer was extrusion coated. This was a physical blend of 76 weight % P2 C70 (PVAXX group) polyvinyl alcohol with 19.0 weight % LDPE 811 A (Eastman Chemical Co., now known as Voridian) and 5.0 weight % PELESTAT 300 (Sanyo Chemical Industries or Tomen America) compatibilizer copolymer which was extrusion coated. The screw speed was 80 rpm and line speed was 0.25 m/s. The resulting resin coverages of the ink-receiving layer was 33.9 g/m².

This image-receiving member was evaluated in the same manner as for Example 6 above. The resulting print had excellent print density and sharpness. Dry time was good. Unlike Example 6 above, no delamination of the ink-receiving layer was noted after a similar period of storage.

### Example 8

In this example of the present invention, the paper support and wire-side coating are identical to those of comparative Example 1. On the face side (or the image-receiving side) a blend of 11 weight % TiO₂, 69 weight % LDPE D4002P (Eastman Chemical Co., now known as Voridian), and 20 weight % EMA OPTEMA TC130 (Exxon Mobil Chemical) compatibilizer resin was co-extruded with the ink-receiver layer. The ink receiver layer that was extrusion was extrusion coated was a physical blend of 76 weight % PVAXX C20 polyvinyl alcohol with 19 weight % LDPE 811A (Eastman Chemical Co., now known as Voridian), and 5 weight % PELESTAT 300 (Sanyo Chemical Industries or Tomen America) compatibilizer copolymer which was extrusion coated. The P2 C20 grade (PVAXX group) polyvinyl alcohol has a 6.2 MFR at 200° C. as measured by ASTM D1238. The line speed was varied from 1.52 to 2.29 m/s. The resulting resin coverages of the ink-receiving layer were as low as 12.2 g/m² at a line speed of 2.29 m/s.

This image-receiving member was evaluated by printing a test image on it using a Hewlett-Packard® Model 5650 inkjet printer loaded with standard ink cartridges. The resulting print had excellent print density, uniformity, and sharpness. Dry time was very good.

### Example 9

In this example of the present invention, the paper support and wire-side coating are identical to those of comparative Example 1. On the face side (or the image-receiving side) a blend of 11 weight % TiO₂, 69 weight % LDPE D4002P (Eastman Chem. Co., now known as Voridian) and 20 weight % EMA OPTEMA TC130 compatibilizer resin was co-extruded with the ink receiver layer. The ink receiver layer that was extrusion coated was a physical blend of 66 weight % P2 C20 (PVAXX group) polyvinyl alcohol with 28.5 weight % LDPE 811A (Eastman Chem. Co., now known as Voridian) and 5 weight % PELESTAT 300 (Sanyo Chemical Industries or Tomen America) compatibilizer copolymer which was extrusion coated. The line speed was varied from 1.52 to 2.29 m/s. The resulting resin coverages of the ink-receiving layer were as low as 12.2 g/m².

This image-receiving member was evaluated in the same manner as Example 9 above. The resulting print had excellent print density, uniformity, and sharpness. Dry time was very good.

The invention has been described in detail with particular reference to certain preferred embodiments thereof, but it will be understood that variations and modifications can be effected within the spirit and scope of the invention.

1. An inkjet recording element comprising a support having thereon at least one swellable, non-porous ink-receiving layer comprising an immiscible mixture of polymers in the form of a continuous phase and dispersed domains of a discontinuous phase, wherein the continuous phase comprises at least one hydrophilic thermoplastic polymer and the dispersed domains comprise at least one hydrophobic thermoplastic polymer that is essentially neutral and non-crosslinked, wherein the composition of the continuous phase and the composition of the discontinuous phase are both thermally stable at 150° C., and wherein the non-porous ink-receiving layer is formed from a material having a melt strength of 0.5 to 20 centiNewtons, wherein the non-porous ink-receiving layer is the product of melt extrusion, over said support, of said immiscible mixture.

2. The inkjet recording element of claim 1 wherein the following equation is satisfied:
$${ϕ}_{2} > {ϕ}_{1} ( \frac{{η}_{2}}{{η}_{1}} ) \qquad ( 1 )$$
wherein η₁ and η₂ are, respectively, melt viscosity at the same shear rate and temperature of the total hydrophobic thermoplastic polymer composition and total hydrophilic thermoplastic polymer composition, and φ₁ and φ₂ are their respective total volume fractions, wherein the sum of φ₁ and φ₂ is equal to one.

3. The inkjet recording element of claim 2 wherein the ink-receiving layer comprises a single hydrophilic thermoplastic polymer and the dispersed domains comprise a single hydrophobic thermoplastic polymer in which case η₁ and η₂ are therefore, respectively, melt viscosity at the same shear rate and temperature of the hydrophobic thermoplastic polymer and the hydrophilic thermoplastic polymer, and φ₁ and φ₂ are the volume fraction of the hydrophobic thermoplastic polymer and hydrophilic thermoplastic polymer, wherein the sum of φ₁ and φ₂ is equal to one.

4. The inkjet recording element according to claim 1, wherein the at least one hydrophilic thermoplastic polymer is about 40 to 85 percent by weight of the total weight of the at least one hydrophobic thermoplastic polymer and the at least one hydrophilic thermoplastic polymer in the layer.

5. (canceled)

6. The inkjet recording element of claim 1 wherein the non-porous ink-receiving layer comprises a mordant.

7. The inkjet recording element of claim 6 wherein the mordant comprises particles of yttrium oxide.

8. The inkjet recording element of claim 1 wherein the hydrophilic thermoplastic polymer is inherently capable of gaining greater than 30 w % by weight of water by absorption over 24 hours at 20° C., measured at 50% R.H.

9. The inkjet recording element of claim 1 wherein the hydrophobic thermoplastic polymer is defined as substantially insoluble in water, wherein less than 5 weight percent dissolves in water over 24 hours at 20° C.

10. (canceled)

11. The inkjet recording element of claim 1 wherein the dispersed domains have an average equivalent diameter of 0.05 to 50 μm.

12. The inkjet recording element of claim 1 wherein the hydrophilic thermoplastic polymer in the ink-receiving layer is selected from the group consisting of, polyvinyloxazoline, polyvinylmethyloxazoline, polyvinylmethyloxazoline, polyoxide, polyether, poly(methacrylic acid), n-vinyl amide, thermoplastic urethane, polyether-polyamide copolymers, polyvinyl pyrrolidinone, polyester ionomers, poly(vinyl alcohol), and derivatives and copolymers of the foregoing.

13. The inkjet recording element of claim 12 wherein the hydrophilic thermoplastic polymer in the ink-receiving layer is selected from the group consisting of poly(vinyl alcohol) and copolymers thereof.

14. The inkjet recording element of claim 13 wherein the hydrophilic thermoplastic polymer in the ink-receiving layer is a copolymer of poly(ethylene vinyl alcohol) and poly(vinyl alcohol), such that the hydrophilic thermoplastic polymer comprises monomer units derived from vinyl alcohol and ethylene.

15. The inkjet recording element of claim 1 wherein the hydrophilic thermoplastic polymer in the ink-receiving layer is a thermoplastic urethane.

16. The inkjet recording element of claim 1 wherein the dispersed domains in the ink-receiving layer further comprise a polyether-group-containing thermoplastic copolymer.

17. The inkjet recording element according to claim 16, wherein the copolymer has repeating copolymer segments, and the number of polyether groups in each of the segments is 2 to 20.

18. The inkjet recording element according to claim 1, wherein the hydrophobic thermoplastic polymer comprises a polyolefin.

19. The inkjet recording element of claim 18 wherein the polyolefin comprises a polymer derived from a monomer selected from propylene or ethylene.

20. The inkjet recording element of claim 19 wherein the polyolefin comprises polyethylene.

21. The inkjet recording element of claim 20 wherein the polyolefin comprises polyethylene, and the ink-receiving layer is adjacent a support comprising cellulosic paper.

22. The inkjet recording element of claim 1 wherein a subbing layer is present between the ink-receiving layer and the support.

23. The inkjet recording element of claim 1 wherein the ink-receiving layer comprises a compound thermally stable at 150° C., either organic or inorganic, capable of functioning as a mordant, comprising particles having a cationic surface or a polymer comprising cationic groups.

24. The inkjet recording element of claim 1 wherein the inkjet recording element is characterized by a gloss of at least about 20.

25. The inkjet recording element of claim 1 wherein the layer thickness of the ink-receiving layer is from 1 to 25 μm.

26. The inkjet recording element of claim 25 wherein the layer thickness of the ink-receiving layer is from 5 to 12 μm.

27. (canceled)

28. The inkjet recording element of claim 1 further comprising, between the support and the ink-receiving layer, a tie or subbing layer.

29-36. (canceled)

37. An inkjet recording element comprising a support having thereon at least one swellable, non-porous ink-receiving layer comprising an immiscible mixture of polymers in the form of a continuous phase and dispersed domains of a discontinuous phase, wherein the continuous phase comprises at least one hydrophilic thermoplastic polymer and the dispersed domains comprise at least one hydrophobic thermoplastic polymer that is essentially neutral and non-crosslinked, and wherein the following equation is satisfied:
$${ϕ}_{2} > {ϕ}_{1} ( \frac{{η}_{2}}{{η}_{1}} ) \qquad ( 1 )$$
wherein η₁ and η₂ are, respectively, melt viscosity at the same shear rate and temperature of the total hydrophobic thermoplastic polymer composition and total hydrophilic thermoplastic polymer composition, and φ₁ and φ₂ are their respective total volume fractions, wherein the sum of φ₁ and φ₂ is equal to one, wherein the non-porous ink-receiving layer is the product of melt extrusion, over said support, of said immiscible mixture.

38. The inkjet recording element of claim 37 wherein the dispersed domains have an average equivalent diameter of 0.05 to 50 μm.
